(19) United States
(12) Patent Application Publication
(10) Pub. No.: US 2026/0143354 A1
(43) Pub. Date: May 21, 2026

(54) AUTO TILT OPTIMIZATION USING REINFORCEMENT LEARNING

(71) Applicant: T-MOBILE INNOVATIONS LLC, Overland Park, KS (US)

(72) Inventors: Vikas RANJAN, Bellevue, WA (US); Gurpreet SINGH, Manteca, CA (US); Bhupesh KANWAR, Dublin, CA (US); Raymond Weimin WU, Newcastle, WA (US); Timothy Michael INDRIERI, San Ramon, CA (US); Santosh Kumar NANDA, Bangalore (IN)

(21) Appl. No.: 18/952,655

(22) Filed: Nov. 19, 2024

(51) Int. Cl. H04W 24/02; H04B 17/318; H04L 41/5009

(52) U.S. Cl. CPC H04W 24/02; H04B 17/328; H04L 41/5009

(57) ABSTRACT

At a high level, the technology disclosed herein relates to base station antenna tilt adjustments based on using one or more auto-tilt optimization models. In embodiments, baseline tilt data and user equipment (UE) measurement data may be used for generating training data for the one or more auto-tilt optimization models. The baseline tilt data and UE measurement data may correspond to a plurality of sectors for a first base station, a plurality of sectors for a second base station, etc. The one or more auto-tilt optimization models may provide key performance indicator (KPI) predictions associated with base station antenna tilt adjustments, and the KPI predictions can be updated as feedback is received upon tilt adjustments made to one or more antennas.

### SUMMARY

A high-level overview of various aspects of the invention are provided here to offer an overview of the disclosure and to introduce a selection of concepts that are further described below in the detailed description section. This summary is not intended to identify key features or essential features of the claimed subject matter, nor is it intended to be used as an aid in isolation to determine the scope of the claimed subject matter.

According to various aspects of the technology disclosed herein, systems, methods, media, etc., are provided for auto-tilt optimization via an auto-tilt optimization system. The auto-tilt optimization system may generate key performance indicator (KPI) predictions using one or more auto-tilt optimization models (e.g., a light gradient boosting machine, a one-dimensional deep neural network, and a gradient boosting regression model, etc., or one or more combinations thereof). In some embodiments, the KPI predictions may be generated using baseline tilt data and user equipment (UE) measurement data associated with sectors of a base station, associated with sectors of a plurality of base stations, and so forth. In some embodiments, the KPI predictions may also be generated using weather data, area data, and ground topology data for each of the associated sectors.

In embodiments, one or more of the KPI predictions may be used for generating a recommended number of sectors for a particular tilt change, such that UEs are provided a maximum data volume and a maximum hexbin (i.e., a maximum coverage) via one or more antenna elements associated with particular sectors. For example, the one or more KPI predictions may be used for determining a vertical tilt angle to be applied to a particular antenna of a particular base station, so that the antenna may be adjusted according to the vertical tilt angle. Additionally, the auto-tilt optimization system may receive feedback upon the change(s) made to the particular antenna(s), so that reinforcement learning may be implemented for additional vertical tilt angle determinations and adjustments to particular antennas associated with particular base stations.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

Aspects of the present disclosure are described in detail herein with reference to the attached Figures, which are intended to be exemplary and non-limiting, wherein:

FIG. 1 depicts an example operating environment for utilizing an auto-tilt optimization engine, in accordance with embodiments herein;

FIG. 2 depicts an example flow chart associated with model development and training operations corresponding to the auto-tilt optimization engine, in accordance with embodiments herein;

FIG. 3 depicts an example flowchart associated with the auto-tilt optimization engine, in accordance with embodiments herein; and

FIG. 4 depicts an example network component client and corresponding functionality associated with the present technology, in accordance with embodiments herein.

### DETAILED DESCRIPTION

The subject matter of the present invention is being described with specificity herein to meet statutory requirements. However, the description itself is not intended to limit the scope of this patent. Rather, the inventors have contemplated that the claimed subject matter might also be embodied in other ways to include different steps or combinations of steps similar to the ones described in this document, in conjunction with other present or future technologies. Terms should not be interpreted as implying any particular order among or between various steps herein disclosed unless and except when the order of individual steps is explicitly described. As such, although the terms “step” and/or “block” may be used herein to connote different elements of systems and/or methods, the terms should not be interpreted as implying any particular order and/or dependencies among or between various components and/or steps herein disclosed unless and except when the order of individual steps is explicitly described. The present disclosure will now be described more fully herein with reference to the accompanying drawings, which may not be drawn to scale and which are not to be construed as limiting. Indeed, the present invention may be embodied in many different forms and should not be construed as limited to the aspects set forth herein.

### Definitions

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms may be found in Newton's Telecom Dictionary, (e.g., 32d Edition, 2022).

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and non-removable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components may store data momentarily, temporarily, or permanently.

“Computer storage media” does not comprise signals per se.

For purposes of this disclosure, the word “including” or “having” has the same broad meaning as the word “comprising.” Further, the word “communicating” has the same broad meaning as the word “receiving,” or “transmitting” facilitated by software or hardware-based buses, receivers, or transmitters using communication media.

In addition, words such as “a” and “an,” unless otherwise indicated to the contrary, include the plural as well as the singular. Thus, for example, the constraint of “a feature” is satisfied where one or more features are present. Additionally, an element in the singular may refer to “one or more.”

The term “some” may refer to “one or more.”

The term “or” includes the conjunctive, the disjunctive, and both (a or b thus includes either a or b, as well as a and b).

The phrase “one or more combinations thereof” may refer to, for example, “at least one of A, B, or C”; “at least one of A, B, and C”; “at least two of A, B, or C” (e.g., AA, AB, AC, BB, BA, BC, CC, CA, CB); “each of A, B, and C”; and may include multiples of A, multiples of B, or multiples of C (e.g., CCABB, ACBB, ABB, etc.). Other combinations may include more or less than three options associated with the A, B, and C examples.

Unless specifically stated otherwise, descriptors such as “first,” “second,” and “third,” for example, are used herein without imputing or otherwise indicating any meaning of priority, physical order, arrangement in a list, or ordering in any way, but are merely used as labels to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

### Technological Overview

By way of background, inefficient manual tilt adjustments compromise network performance and customer experience. For example, manual tilt adjustments involve having physical access to the antenna, which can be time-consuming and tedious when the antennas are located in remote or locations that aren't easily accessible, and may require technicians to travel to the remote locations and climb towers, thereby leading to delays in optimizing network performance. In addition, manual antenna adjustments may not be efficient in responding to rapid changes in network conditions (e.g., fluctuations in traffic patterns, user density, or environmental factors). Further, the manual adjustments can sometimes result in varying accuracy and precision based on technician experience, and small errors in tilt angle adjustments may negatively affect network performance, coverage, and signal quality.

Embodiments of the technology discussed herein provide various improvements to these challenges discussed above. For example, the technology described herein can improve upon network optimization without delays so that changes to the network conditions (e.g., fluctuations in traffic patterns, user density, or environmental factors) can be detected and factored into the auto tilt optimization in a faster, more accurate and precise way. To illustrate, reinforcement learning can be used for model updating and optimizations so that the adjustments to the antenna(s) can be determined based on continually learning through interactions with the user devices within a geographical environment and receiving feedback via rewards or penalties, such that the tilt adjustments are determined through current network conditions and experiences instead of solely relying on pre-existing data that may not apply to a current network condition or environment.

In an embodiment, an auto-tilt optimization system is provided. The auto-tilt optimization system may comprise one or more processors and computer memory storing computer-usable instructions that, when executed by the one or more processors, cause the one or more processors to perform operations. The operations may comprise receiving baseline tilt data and user equipment (UE) measurement data associated with sectors of a base station. The operations may also comprise training one or more auto-tilt optimization models using training data generated based at least in part on the baseline tilt data and the UE measurement data. The operations may also comprise determining a vertical tilt angle to be applied to an antenna of the base station based on key performance indicator (KPI) predictions associated with a plurality of vertical tilt angles, the KPI predictions generated using the trained one or more auto-tilt optimization models. The operations may also comprise adjusting the antenna of the base station based on the vertical tilt angle.

In another embodiment, a method for auto-tilt optimization is provided. The method may comprise receiving baseline tilt data and user equipment (UE) measurement data associated with sectors of a base station. The method may also comprise training one or more auto-tilt optimization models using training data generated based at least in part on the baseline tilt data and the UE measurement data. The method may also comprise determining a vertical tilt angle to be applied to an antenna of a second base station based on key performance indicator (KPI) predictions associated with a plurality of vertical tilt angles for the antenna of the second base station, the KPI predictions generated using the trained one or more auto-tilt optimization models. The method may also comprise adjusting the antenna of the second base station based on the vertical tilt angle.

In another example embodiment, one or more computer storage media having computer-executable instructions embodied thereon, that when executed by at least one processor, cause the at least one processor to perform a method. The method may comprise receiving baseline tilt data and user equipment (UE) measurement data associated with sectors of a base station. The method may comprise training one or more auto-tilt optimization models using training data generated based at least in part on the baseline tilt data and the UE measurement data. The method may also comprise determining a vertical tilt angle to be applied to an antenna of the base station based on key performance indicator (KPI) predictions associated with a plurality of vertical tilt angles corresponding to the antenna and a sector of the sectors, the KPI predictions generated using the trained one or more auto-tilt optimization models. The method may also comprise causing the antenna of the base station to be adjusted based on the vertical tilt angle.

### Example Operating Environments

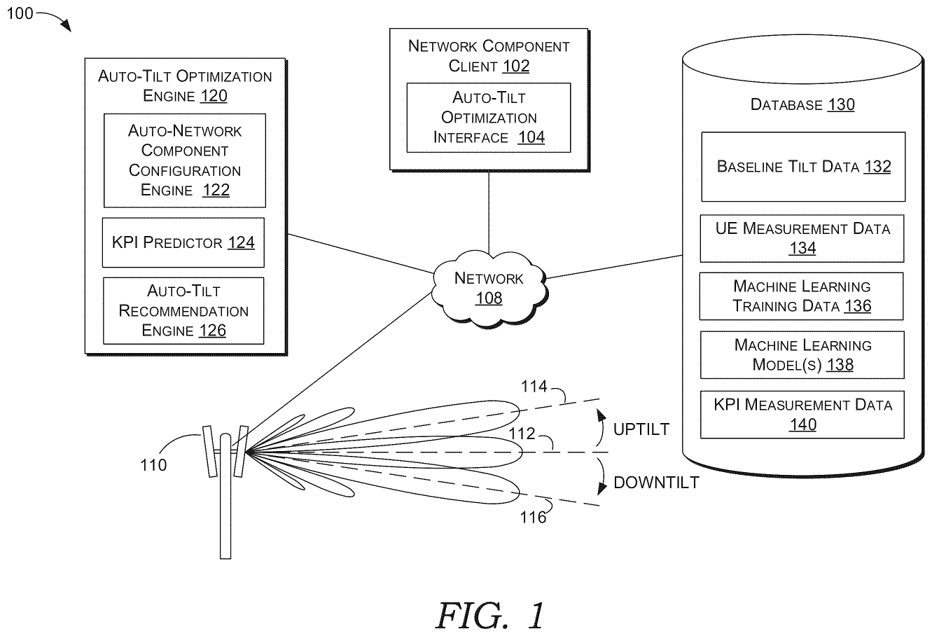

Turning now to FIG. 1, example operating environment 100 is illustrated in accordance with one or more embodiments disclosed herein. At a high level, the example operating environment 100 comprises network component client 102 having auto-tilt optimization interface 104, network 108, base station 110 providing beams having baseline 112, up tilt 114, and down tilt 116, auto-tilt optimization engine 120, and database 130. The auto-tilt optimization engine 120 may comprise auto-network component configuration engine 122, key performance indicator (KPI) predictor 124, and auto-tilt recommendation engine 126. The database 130 may comprise baseline tilt data 132, user equipment (UE) measurement data 134, machine learning training data 136, machine learning model(s) 138, and KPI measurement data 140.

Example operating environment 100 is but one example of a suitable environment for the technology and techniques disclosed herein, and is not intended to suggest any limitation as to the scope of use or functionality of the invention. Neither should the environment 100 be interpreted as having any dependency or requirement relating to any one or combination of components illustrated. For example, other embodiments of example operating environment 100 may have additional network component clients or other configurations of database 130 (e.g., database 130 may be a distributed computing environment encompassing multiple computing devices for storing one or more of the node data separately).

Network component client 102 may be a device that has the capability of communicating (e.g., transmitting or receiving one or more signals to or from) with one or more of the base station 110, auto-tilt optimization engine 120, and database 130 over the network 108. In some embodiments, the network component client 102 may be a “user device,” “computing device,” “mobile device,” “client,” “user equipment (UE),” or “wireless communication device.” In some embodiments, the network component client 102 may be a server. The network component client 102, in some implementations, may take on a variety of forms, such as a PC, a laptop computer, a tablet, a mobile phone, a PDA, a server, an internet-of-things device, a wireless local loop station, an Internet of Everything device, a machine type communication device, an evolved or enhanced machine type communication device, or any other device that is capable of communicating over the network 108.

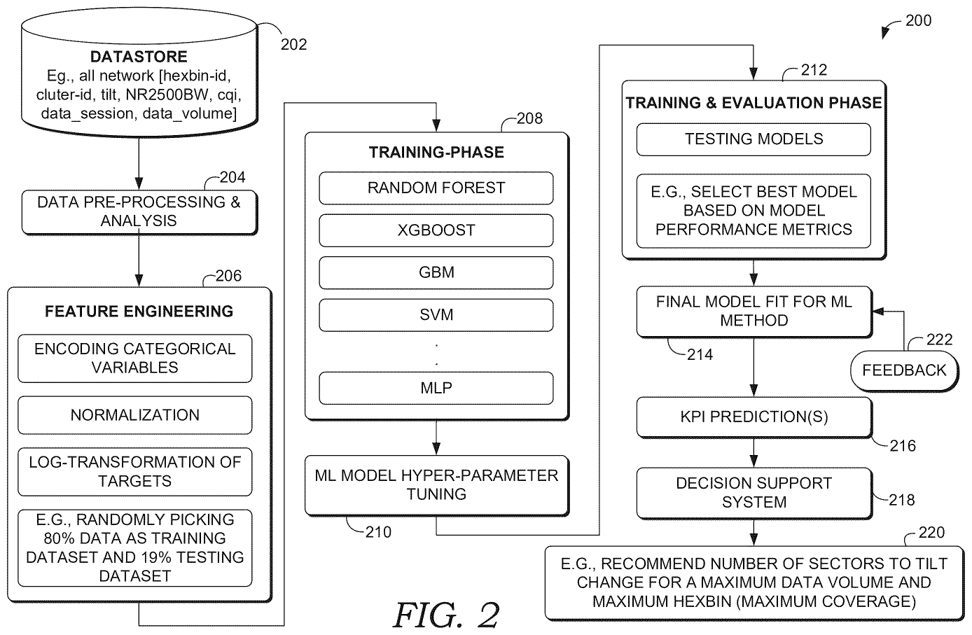

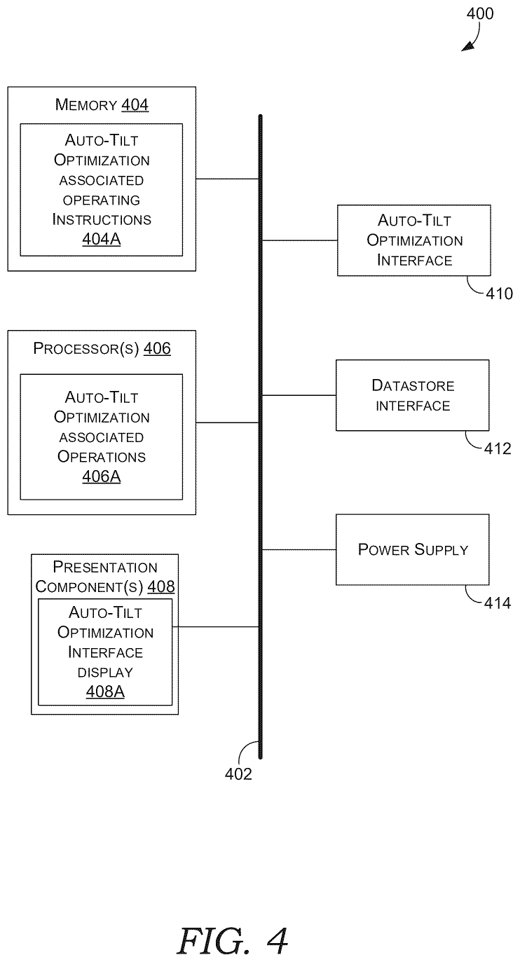

The network component client 102 may be, in an embodiment, capable of providing the KPI prediction(s) of step 216 or the recommended number of sectors to tilt change at step 220 from FIG. 2 via the auto-tilt optimization interface 104. In some embodiments, the network component client 102 may be capable of providing a determined vertical tilt angle to be applied to an antenna via the auto-tilt optimization interface 104. In some embodiments, the network component client 102 may be network component client 400 described herein with respect to FIG. 4.

In embodiments, the auto-tilt optimization interface 104 may be one or more presentation components 408 of FIG. 4. In embodiments, the auto-tilt optimization interface 104 may display image data, text data, extended reality data, other types of data, or one or more combinations thereof, based on one or more operations of the auto-tilt optimization engine 120 (e.g., operations associated with the auto-network component configuration engine 122, KPI predictor 124, and auto-tilt recommendation engine 126, etc.).

In embodiments, the network 108 may include one or more of a local area network (LAN), a wide area network (WAN), a mesh network, a hybrid network, a plurality of networks, another type of network, or one or more combinations thereof. In some embodiments, one or more components (e.g., network component client 102, base station 110, auto-tilt optimization engine 120, etc.) illustrated within the example operating environment 100 may communicate over the network 108 via the Internet, another public or private network, etc., or one or more combinations thereof. In some embodiments, the network 108 includes 5G standalone technology (independent of 4G technology), 5G non-standalone technology, LTE network technology, another generation network technology, 802.11x, etc., or one or more combinations thereof.

In embodiments, the auto-tilt optimization engine 120 may comprise computing devices (e.g., one or more servers). In some embodiments, the auto-tilt optimization engine 120 may be a single server, a distributed computing environment encompassing multiple computing devices located at the same physical geographical location or at different physical geographical locations, another type of server environment, etc. In embodiments, the auto-tilt optimization engine 120 may comprise one or more processors, one or more electronics devices, one or more hardware devices, one or more electronics components, one or more logical circuits, one or more memories, one or more software codes, one or more firmware codes, etc., or one or more combinations thereof.

The auto-tilt optimization engine 120 may access the database 130 to execute tasks (e.g., associated with the associated with the auto-network component configuration engine 122, KPI predictor 124, and auto-tilt recommendation engine 126, etc.). For example, a user—via the network component client 102 (e.g., via the auto-tilt optimization interface 104)—may transmit a request to communicate with the auto-tilt optimization engine 120. As another example, the auto-network component configuration engine 122 may automatically configure network elements associated with base station 110, antennas of the base station 110, backhaul links, etc. In some embodiments, the auto-network component configuration engine 122 may continuously analyze baseline tilt data 132 and UE measurement data 134 associated with the base station 110 and the baseline 112, up tilt 114, and down tilt 116, and store the baseline tilt data 132 and UE measurement data 134 at database 130. In embodiments, the auto-network component configuration engine 122 may make real-time or near real-time adjustments to base station parameters (e.g., transmission power, antenna tilt, vertical antenna tilt, handover thresholds, frequency allocation, etc.). In some embodiments, auto-network component configuration engine 122 may be a Self-Optimizing Network (SON) network architecture.

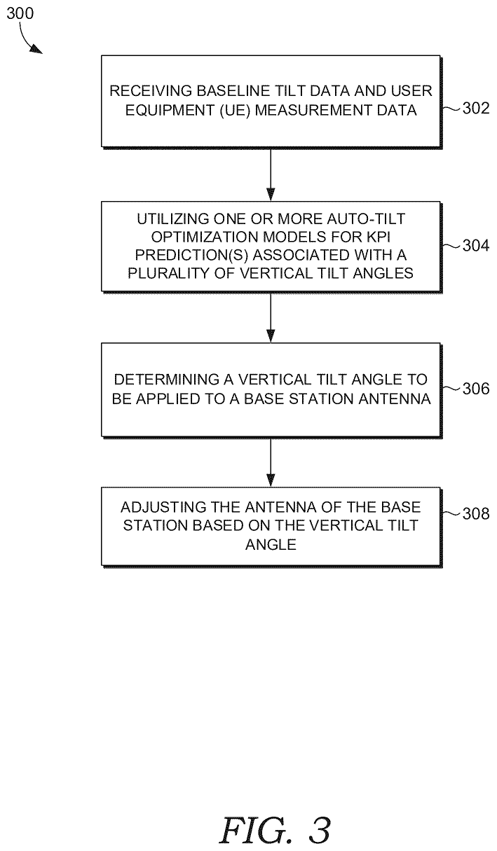

In embodiments, the auto-tilt optimization engine 120 may receive baseline tilt data 132 and user equipment (UE) measurement data 134 (e.g., from database 130 or base station 110) associated with one or more sectors of the base station 110. In embodiments, the baseline tilt data 132 and user equipment (UE) measurement data 134 may include the data from the data store 202 of FIG. 2 described herein. In embodiments, the baseline tilt data 132 and user equipment (UE) measurement data 134 may include the data described at step 302 of FIG. 3 discussed herein. As an example, the baseline tilt data 132 and user equipment (UE) measurement data 134 may include network current RSRP (e.g., associated with base station 110 and network 108), a number of UEs communicating with a particular antenna or sector of the base station 110, downlink volume associated with a particular antenna or sector of the base station 110, frequency bandwidth associated with a particular sector of the base station 110, antenna gain associated with a particular sector of the base station 110, a height of the particular antenna, clutter, daily frequency data that the UEs located within a particular sector of the base station 110 have used, location data with the UEs in communication with the base station 110, timing advance and the hexbin associated with the UEs in communication with the base station 110, etc.

In embodiments, the one or more auto-tilt optimization models of the machine learning model(s) 138 may be trained (e.g., via the auto-tilt optimization engine 120 or the network component client 102) using machine learning training data 136 generated based at least in part on the baseline tilt data 132 and the UE measurement data 134. In some embodiments, training the one or more auto-tilt optimization models may comprise one or more of the steps 204-214 discussed herein with respect to FIG. 2. In some embodiments, the machine learning training data 136 is generated using a set of baseline tilt data 132 and UE measurement data 134 for a plurality of antennas each corresponding to the base station 110. For example, in some embodiments, the machine learning training data 136 generated for a first antenna of the base station 110 associated with a first sector of the base station 110 may include baseline tilt data 132 and UE measurement data 134 for a plurality of antennas of a second sector of the base station 110. Continuing this example, the plurality of antennas of the second sector may be within a threshold distance from the first antenna, wherein the plurality of antennas of the second sector are closer to the first antenna than another set of antennas of the second sector. As another example, the plurality of antennas of the second sector may be closer to the first antenna than another set of antennas of a third sector of the base station. Stated differently, in some embodiments, baseline tilt data 132 and UE measurement data 134 for generating the machine learning training data 136 may be from one or more other sectors of the base station 110, such that vertical tilt changes are determined using a different sector's data.

In some embodiments, the baseline tilt data 132 and the UE measurement data 134 used for generating the machine learning training data 136 for the first antenna may include historical baseline tilt data 132 and the UE measurement data 134 for the sector associated with the first antenna. In some embodiments, the baseline tilt data 132 and the UE measurement data 134 associated with the base station 110 may be used for generating the machine learning training data 136 for an antenna of a base station other than the base station 110. For example, vertical tilt changes may be determined for the antenna of the base station other than the base station 110 using the baseline tilt data 132 and the UE measurement data 134 of a particular antenna of base station 110 having a closest distance to the antenna in which the vertical tilt change is to be determined. For instance, the closest distance may be based on the base station 110 being the closest site to the other base station.

In some embodiments, a portion of the machine learning training data 136 may be adjusted based on feedback (e.g., feedback 222 of FIG. 2) received in response to an adjustment to a vertical tilt angle of an antenna of the base station 110. For example, the auto-tilt optimization engine 120 may receive additional baseline tilt data 132 and user equipment (UE) measurement data 134 from the base station 110 for the sector involving the antenna that was adjusted. In some embodiments, the adjusted machine learning training data 136 may be used to re-train the auto-tilt optimization models of the machine learning model(s) 138 for generating KPI(s) for readjustments to the same antenna that was previously adjusted. In some embodiments, the adjusted machine learning training data 136 may be used to re-train the auto-tilt optimization models of the machine learning model(s) 138 for generating KPI(s) for another antenna within a threshold distance from the adjusted antenna. In some embodiments, machine learning training data 136 may be updated based on applying a Reinforcement Human Feedback Loop and a maximum rewards associated with maximum coverage value (e.g., using a Q-Learning), and the updated machine learning training data 136 may be used to re-train the auto-tilt optimization models of the machine learning model(s) 138 for subsequent vertical tilt angle change determinations.

In embodiments, auto-tilt recommendation engine 126 determines a vertical tilt angle to be applied to an antenna of the base station 110 based on key performance indicator (KPI) predictions determined by the KPI predictor 124 using KPI measurement data 140. For example, the KPI predictions and KPI measurement data 140 may be associated with a plurality of vertical tilt angles for the antenna based on a current vertical tilt angle, the KPI predictions may be generated by using the trained one or more auto-tilt optimization models. In an example embodiment, the trained one or more auto-tilt optimization models may include a Light GBM, a Deep Learning (One-Dimensional), and a Catboost Regression model (e.g., selected based on each of these models having an RMSE below the threshold, a MAPE below the threshold, and an Absolute Percentage Error below the threshold).

In some embodiments, the KPI predictor 124 generates the KPI prediction(s) for the antenna based on the determined effects from multiple antennas associated with another site that is closest to the antenna (e.g., a base station that is closest to the base station 110). In some embodiments, the KPI prediction(s) are generated based on KPI measurement data 140 including weather data, area data, ground topology data, etc., for the coverage area for the antenna. In some embodiments, the KPI prediction(s) may be generated based on the KPI measurement data 140 including changes to vertical tilt angles of the antenna (e.g., the delta angles −100, 100, −200, 200, etc.) and based on the current vertical tilt angle of the antenna. In some embodiments, the KPI prediction(s) are generated by preparing the vertical tilt angle change for the antenna (e.g., with input parameters: X₁=[Input₁, Input₂ . . . Input_{N}, θ+Δθ₁]; X₂=[Input₁, Input₂ . . . Input_{N}, θ+Δθ₂]; X₃=[Input₁, Input₂ . . . Input_{N}, θ+Δθ₃]; X₄=[Input₁, Input₂ . . . Input_{N}, θ+Δθ₄]). In embodiments, KPI predictor 124 generates the KPI prediction(s) outputs with the tilt-change input datasets that are evaluated based on the outputs (e.g., outputs Y1, Y2, Y3, Y4; Y=Model (X)). In some embodiments, the KPI predictions may include RSRP associated with the sector of the antenna of the base station 110, covered hexbin associated with the sector, and downlink volume per user device associated with the sector.

In embodiments, the auto-tilt recommendation engine 126 determines the vertical tilt angle to be applied to the antenna based on steps 204-220 of FIG. 2. Additionally or alternatively, in embodiments, the auto-tilt recommendation engine 126 determines the vertical tilt angle to be applied to the antenna based on steps 302-306 of FIG. 3. In embodiments, based on the auto-tilt recommendation engine 126 provides a recommended number of sectors or antennas to apply a tilt change (e.g., for maximum data volume and maximum hexbin for each sector associated with each of the sectors being recommended for tilt change). In embodiments, the auto-tilt recommendation engine 126 provides additional vertical tilt angles to be applied to the antenna at later times. In embodiments, the auto-tilt recommendation engine 126 provides additional vertical tilt angles to be applied to a plurality of antennas associated with the base station 110 or another base station.

### Example Flowcharts

Having described the example embodiments discussed above, an example flowchart 200 is described below with respect to FIG. 2. Example flowchart 200 begins with data store 202. The data store 202 may include one or more of an entire sector's data, such as a hexbin identifier for each coverage area provided by antennas of a base station that each correspond to the sector, cluster identifiers associated with clusters of antennas, a Channel Quality Indicator (CQI) associated with sectors of a base station, CQI for other base stations and associated sectors, data session data associated with each sector, a mechanical tilt angle for each antenna, a current electrical tilt angle for each antenna, phase shift parameters for each antenna,, etc., or one or more combinations thereof. In some embodiments, the data store 202 organizes the stored data via the hexbin identifier, the cluster identifiers, another type of identifier, etc., or one or more combinations thereof. In some embodiments, the data store 202 continuously receives data (e.g., from a plurality of user devices communicating with one or more base stations, from a plurality of base stations, etc.). In some embodiments, the data store 202 includes baseline tilt data 132 and UE measurement data 134 of FIG. 1.

At step 204, the data from data store 202 is pre-processed and analyzed. By way of example, the data from the data store 202 may be prepared via a data cleaning technique (e.g., missing data identification and imputation), a de-duplication technique (e.g., using logistic regression or decision tree), a noise removal technique (e.g., low-pass filtering, a moving average filter, Kalman filtering), etc. At step 206, feature engineering may include encoding categorical variables (e.g., converting categorical data into numerical formatting and applying a machine learning algorithm), normalization, log-transformations of targets, random selection of a percentage of the data for generating a training dataset and another percentage as the testing dataset, etc.

Step 208 includes a training phase. For example, in some embodiments, the training phase may include machine learning training data 136 from FIG. 1. As another example, the training phase may include data splitting for model training. For instance, 80 percent of the data from step 206 may be used as training data and the remaining 20 percent of the data from step 206 may be used for testing (e.g., X_train, Y_train, X_test, Y_test). For example, X_train=80% Input Variables; Y_train=80% Output Variables; X_test=19% Test Input Variable; and Y_test=19% Test Output Variable; such that 99 percent is for training and testing, and 1 percent of the data is for validation. In embodiments, the training phase includes using this data to train one or more auto-tilt optimization models (e.g., a light gradient boosting machine, a one-dimensional deep neural network, a gradient boosting regression model, etc.). In embodiments, the one or more auto-tilt optimization models may include a deep learning model, a LightGBM, a Catboost Regressor, an XGBoost, a gradient boosting machine (GBM), Adaboost, a Support Vector Regressor, another type of model, or one or more combinations thereof.

Step 210 includes machine learning hyper-parameter tuning. For example, hyper-parameter tuning the one or more auto-tilt optimization models may include controlling a learning rate for each of the one or more auto-tilt optimization models (e.g., based on a loss gradient), layer determination, batch size determinations, regularization parameter determinations, applying a grid search, applying a random search, applying Bayesian optimization, genetic algorithm application, etc.

Step 212 includes a training and evaluation phase. The training and evaluation phase may include testing each of the auto-tilt optimization models and selecting one or more of the auto-tilt optimization models (e.g., selecting based on model performance metrics, such as R², Root Mean Squared Error (RMSE), Mean Absolute Percentage Error (MAPE), etc.). In some embodiments, the one or more of the auto-tilt optimization models selected may be validated based on validation data (e.g., the 1 percent from step 208). For example, one or more of the auto-tilt optimization models may be selected based on particular validation precision accuracy, wherein the selected model(s) have a lower RMSE, a lower Absolute Percentage Error, and a lower MAPE than the other models. As another example, the one or more of the auto-tilt optimization models may be selected based on having an RMSE below a threshold, a MAPE below a threshold, and an Absolute Percentage Error below a threshold. In one embodiment, a Light GBM, a Deep Learning (One-Dimensional), and a Catboost Regression model are selected as the auto-tilt optimization models based on each of these models having an RMSE below the threshold, a MAPE below the threshold, and an Absolute Percentage Error below the threshold. In some embodiments, the training and evaluation at step 212 may be performed offline, and the Light GBM, Deep Learning (One-Dimensional), and Catboost Regression model are then directly applied to particular sector data (e.g., network current RSRP, number of UEs, Down Link volume, frequency bandwidth, Antenna gain, height, clutter, etc.) for online processing.

In some embodiments, a final model fit may be applied to the Light GBM, Deep Learning (One-Dimensional), and Catboost Regression model at step 214 before directly applying them to particular sector data. In some embodiments, the particular sector data may include sector data from a closest site distance from the antenna in which the vertical tilt angle is to be determined, the particular sector data including computed effects from the multiple antennas associated with the closest site. In some embodiments, the one or more of the auto-tilt optimization models may be reselected after receiving feedback 222. In some embodiments, another auto-tilt optimization model may be added for selection. Based on the additional auto-tilt optimization model (e.g., adding new candidate models), model performance may vary, and as such, the reselection may include steps 206, 208, 210, 212, and 214 may be re-performed based on the additional auto-tilt optimization model being added as a new candidate.

At step 216, KPI prediction(s) are generated (e.g., based on the final model fit applied to the Light GBM, Deep Learning (One-Dimensional), and Catboost Regression model at step 214). In some embodiments, the KPI prediction(s) are generated for an antenna associated with a first sector based on sector data from a second sector associated with a closest site having the lowest distance from the antenna relative to other sites. In some embodiments, the KPI prediction(s) are generated for the antenna based on the determined effects from multiple antennas associated with the site that is closest to the antenna. In some embodiments, the KPI prediction(s) are generated based on weather data, area data, ground topology data, etc., for the coverage area for the antenna. The KPI prediction(s) may be generated based on changes to vertical tilt angles of the antenna (e.g., the delta angles −100, 100, −200, 200, etc.) based on the current vertical tilt angle.

In some embodiments, the KPI prediction(s) are generated by preparing the tilt change with input parameters: X₁=[Input₁, Input₂ . . . Input_{N}, θ+Δθ₁]; X₂=[Input₁, Input₂ . . . Input_{N}, θ+Δθ₂]; X₃=[Input₁, Input₂ . . . Input_{N}, θ+Δθ₃]; X₄=[Input₁, Input₂ . . . Input_{N}, θ+Δθ₄]. In embodiments, prediction of outputs with the tilt-change input datasets are evaluated based on the outputs (e.g., outputs Y1, Y2, Y3, Y4; Y=Model (X)).

At step 218, the KPI prediction(s) are provided to a Decision Support System (DSS) (e.g., of a Self-Optimizing Network capable of managing and automating network functions) and the DSS ranks the tilt angles and determines a best vertical tilt angle for the antenna based on the KPI prediction(s) and the ranking. In some embodiments, the DSS generates a probability score for each of these changes to the vertical tilt angle for the antenna, as per the ranking (e.g., corresponding to the tilt+delta tilt angle). In some embodiments, the rankings or the probability scores to a Reinforcement Human Feedback Loop, which determines a variance between the expected coverage and the observed coverage (e.g., expected hexbin and observed hexbin).

The Reinforcement Human Feedback Loop may update the system or model performance by updating the particular vertical tilt angle for the antenna (e.g., to maximum coverage and optimize the policy). In embodiments, a maximum rewards associated with maximum coverage value may be applied (e.g., using a Q-Learning Rewards model that includes a model-free reinforcement learning algorithm used to find the optimal action-selection policy for a given finite Markov Decision Process and allowing an agent to learn how to behave in an environment by interacting with it and receiving rewards, wherein the reward model defines how the rewards are assigned to actions taken in particular states), and this feedback loop can optimized the policy with the maximum rewards. The Reinforcement Human Feedback Loop framework can cause the adjustments to the vertical tilt angle (e.g., software controlled) with maximum coverage for the sector by the antenna.

At step 220, a recommended number of sectors to apply a tilt change can be provided for maximum data volume and maximum hexbin for each sector associated with each of the number of sectors being recommended for tilt change.

Example flowchart 300 of FIG. 3 begins at step 302 with receiving baseline tilt data and user equipment (UE) measurement data. In embodiments, the baseline tilt data and UE measurement data may correspond to a plurality of sectors associated with a base station and a plurality of antennas associated with the base station and each of the sectors. In embodiments, the baseline tilt data and UE measurement data may correspond to a plurality of base stations within a threshold range from the base station, sectors for each of the plurality of base stations, etc. In embodiments, the baseline tilt data and UE measurement data may be associated with particular time periods during a particular day. In some embodiments, the baseline tilt data and the UE measurement data may be UE measurement data 134 and baseline tilt data 132 of FIG. 1. In some embodiments, the baseline tilt data and the UE measurement data may be retrieved from database 130 of FIG. 1 or data store 202 of FIG. 2. In some embodiments, the baseline tilt data or the UE measurement data may be received based on the auto-tilt optimization associated operations 406A of FIG. 4.

In some embodiments, the baseline tilt data and the UE measurement data include Reference Signal Received Power (RSRP) (e.g., linear average of the power levels of the resource elements that carry cell-specific reference signals within the downlink signal and measured in decibels relative to milliwatt (dBm) or decibels relative to one milliwatt (dBm), indicating the strength of the downlink signal from the base station and associated with quality of the connection) associated with each of the sectors of the base station, Reference Signal Received Quality (RSRQ) associated with each of the sectors of the base station, Received Signal Strength Indicator (RSSI) associated with each of the sectors of the base station, Signal to Interference plus Noise Ratio (SINR) associated with each of the sectors of the base station, a Channel Quality Indicator (CQI) associated with each of the sectors of the base station, a Bit Error Rate (BER) associated with each of the sectors of the base station, a Packet Loss Rate (PLR) associated with each of the sectors of the base station, a number of UEs utilizing a frequency band provided at each of the sectors, an amount of data transmitted to the UEs within each of the sectors over a downlink provided by the base station, an antenna gain associated with each antenna for each of the sectors, a height of the base station, a height of the antennas associated with each of the sectors, etc., or one or more combinations thereof.

In some embodiments, the baseline tilt data may include a mechanical tilt angle associated with an initial physical angle that an antenna is mounted and associated with an antenna beam and a horizontal plane, installation coordinates (e.g., latitude, longitude, height) associated with the antenna, an azimuth angle associated with the antenna orientation, a current electrical tilt angle associated with an upward or downward direction for the antenna beam within a radiation pattern, phase shift parameters of the antenna, an electronic control configuration for the antenna, antenna model specification data, historical mechanical or electric tilt adjustments to the antenna, historical antenna beam propagation data, etc., or one or more combinations thereof.

At step 304, one or more auto-tilt optimization models may be utilized for key performance indicator (KPI) prediction(s) associated with a plurality of vertical tilt angles for a particular antenna of the base station. In some embodiments, the KPI prediction(s) may be generated using one or more auto-tilt optimization models trained via training data generated based at least in part on the baseline tilt data and the UE measurement data. In some embodiments, the KPI predictor 124 of FIG. 1 predicts one or more KPIs associated with a plurality of vertical tilt angles for the antenna of the base station based on the machine learning model(s) 138 trained using the machine learning training data 136 of FIG. 1. In some embodiments, the KPI prediction(s) correspond to KPI prediction(s) 216 of FIG. 2.

In some embodiments, the training data is generated using a set of baseline tilt data and UE measurement data for a plurality of antennas each corresponding to one of a plurality of base stations, the plurality of base stations including the base station having the antenna that the KPI prediction(s) are generated for. In some embodiments, the one or more auto-tilt optimization models include a light gradient boosting machine, a one-dimensional deep neural network, a gradient boosting regression model, another type of model, or one or more combinations thereof. By way of example, the KPI prediction(s) may be generated for the antenna based on a plurality of changes in the vertical tilt angles (e.g., delta angles −100, 100, −200, 200) to the antenna based on its current vertical tilt angle (θ+Δθ), such that the one or more auto-tilt optimization models predict a plurality of KPIs (e.g., RSRP, covered hexbin, downlink volume per user, total unique user) for the antenna for each of the changes in the vertical tilt angles.

The total unique user KPI may be associated with a distinct count of individual UEs that have connected to or communicated with an antenna beam associated with the particular antenna over a given period of time. The total unique user may be identified via a user identifier (e.g., International Mobile Subscriber Identity (IMSI)). For example, the unique users may each be identified once, regardless of that user reconnecting to the base station within the particular time frame. As another example, the KPI predictions may include a predicted RSRP for the antenna that is associated with the sectors of the base station, such that the predicted RSRP for a particular change of vertical tilt angle for the antenna takes into account the radiation patterns of the other sectors, power supplies associated with the downlink volume per user device associated with each of the sectors of the base station, etc.

In yet another example, the KPI predictions may include a predicted covered hexbin associated with the sectors of the base station, such that the predicted covered hexbin for a particular change of vertical tilt angle for the antenna takes into account the covered hexbin of the other sectors. In yet another example, the KPI predictions may include a predicted downlink volume per user device associated with the sectors of the base station, such that the predicted downlink volume for a particular change of vertical tilt angle for the antenna takes into account the downlink volume for the other sectors.

As another example, the KPI predictions may correspond to an RSRP associated with another base station (e.g., within a threshold distance), such that the predicted RSRP for a particular change of vertical tilt angle for the antenna takes into account RSPR values of a nearby base station. As another example, the KPI predictions may correspond to covered hexbin associated with an antenna of the second base station, such that the predicted covered hexbin for a particular change of vertical tilt angle for the antenna takes into account covered hexbin associated with the nearby base station. As another example, the KPI predictions may correspond to downlink volume per user device associated with an antenna of the second base station, such that the predicted downlink volume per user device for a particular change of vertical tilt angle for the antenna takes into account downlink volume per user device associated with the nearby base station.

In some embodiments, the KPI predictions are generated by providing weather data, area data, and ground topology data for each of the sectors of the base station as the training data to the one or more auto-tilt optimization models. For example, the weather data may include temperature data, humidity data, wind speed and direction data, precipitation data, visibility data, etc., or one or more combinations thereof. In some embodiments, the area data may correspond to a population density associated with an antenna beam coverage area, interference sources (e.g., another base station) associated with a coverage area, building densities associated with the coverage area, road traffic data associated with the coverage area, etc., or one or more combinations thereof. In some embodiments, the ground topology data may include elevation data associated with the coverage area, terrain slope associated with the coverage area, terrain composition (e.g., bodies of water) associated with the coverage area, geological data, etc., or one or more combinations thereof. In some embodiments, one or more of the weather data, the area data, and the ground topology data may correspond to historical data for the antenna in which the KPI is being predicted, current data for the antenna in which the KPI is being predicted, future data for the antenna in which the KPI is being predicted, or one or more combinations thereof.

At step 306, a vertical tilt angle, to be applied to the antenna of the base station, is determined (e.g., by auto-tilt optimization engine 120 of FIG. 1, by decision support system at step 218 of FIG. 2) based on utilizing the one or more auto-tilt optimization models. In some embodiments, the vertical tilt angle is determined based on providing a change, between a current vertical tilt angle of the antenna and each of a plurality of vertical tilt angles associated with the KPI predictions, to the one or more auto-tilt optimization models. For example, the change in the vertical tilt angle (e.g., delta angles −100, 100, −200, 200) may be based on the antenna's current vertical tilt angle (θ+Δθ), such that the one or more auto-tilt optimization models predict one or more KPIs (e.g., RSRP, covered hexbin, downlink volume per user, total unique user) upon changing the vertical tilt angle of the antenna to the new vertical tilt angle. In some embodiments, the vertical tilt angle is determined based on one or more of the KPIs being above a threshold. To illustrate, the one or more auto-tilt optimization models may be used to predict one or more KPIs for first vertical tilt angle, a second vertical tilt angle, and a third vertical tilt angle (each of these being different than a current vertical tilt angle of the antenna), and the first vertical tilt angle may be selected over the second vertical tilt angle and the third vertical tilt angle based on the predicted RSRP KPI, the predicted covered hexbin KPI, the predicted downlink volume per user KPI, the predicted total unique user KPI, another KPI, or one or more combinations thereof, for each of the first vertical tilt angle, the second vertical tilt angle, and the third vertical tilt angle.

For example, the first vertical tilt angle may be the determined tilt angle based on the predicted covered hexbin KPI for the first vertical tilt angle being better than the predicted covered hexbin KPI for the second vertical tilt angle and the third vertical tilt angle. As another example, the first vertical tilt angle may be the determined tilt angle based on the predicted RSRP KPI for the first vertical tilt angle being higher than the predicted RSRP KPI for the second vertical tilt angle and the third vertical tilt angle. As another example, the first vertical tilt angle may be the determined tilt angle based on the predicted downlink volume per user KPI for the first vertical tilt angle being lower than the predicted downlink volume per user KPI for the second vertical tilt angle and the third vertical tilt angle. In yet another example, the first vertical tilt angle may be the determined tilt angle based on the predicted total unique user KPI for the first vertical tilt angle being lower than the predicted downlink volume per user KPI for the second vertical tilt angle and the third vertical tilt angle.

As another illustration, the first vertical tilt angle may be determined over the second vertical tilt angle and the third vertical tilt angle based on one or more of the predicted RSRP KPI, the predicted covered hexbin KPI, the predicted downlink volume per user KPI, the predicted total unique user KPI, another KPI, or one or more combinations thereof, for the first vertical tilt angle satisfying one or more thresholds. By way of example, the first vertical tilt angle may be determined over the second vertical tilt angle and the third vertical tilt angle based on having two or more predicted KPIs that each satisfy a threshold, and based on the second vertical tilt angle and the third vertical tilt angle having less than two predicted KPIs satisfying a threshold. In another example, the first vertical tilt angle may be determined over the second vertical tilt angle and the third vertical tilt angle based on the first vertical tilt angle having a higher weighted KPI satisfying a threshold than another KPI of the second vertical tilt angle and the third vertical tilt angle satisfying a threshold.

At step 308, the antenna of the base station is adjusted based on the determined vertical tilt angle. In some embodiments, a second vertical tilt angle may be determined to be applied to a second antenna of the base station. For example, the second antenna of the base station may correspond to a different sector than the sector of the other adjusted antenna. In embodiments, the second vertical tilt angle may be determined based on a second set of KPI predictions associated with a plurality of vertical tilt angles for the second antenna, the second set of KPI predictions being generated using the trained one or more auto-tilt optimization models. In some embodiments, the second vertical tilt angle may be determined using a different auto-tilt optimization model than the one or more auto-tilt optimization models used for the other adjusted antenna. The second antenna of the base station may then be based on the second vertical tilt angle determined.

Continuing the second vertical tilt angle example, feedback, from a network component client (e.g., network component client 102 of FIG. 1, feedback 222 of FIG. 2, network component client 400 of FIG. 4), may be received based on the second vertical tilt angle adjustment (e.g., the feedback including a covered hexbin associated with the second antenna of the base station, RSPR values associated with the second antenna adjustment, weather data for the coverage area provided by the second antenna, area data for the coverage area provided by the second antenna, ground topology data for the coverage area provided by the second antenna, baseline tilt data associated with the adjusted second antenna, UE measurement data associated with a beam provided by the adjusted second antenna, etc.). In some embodiments, the feedback is used to adjust a portion of the training data based on the feedback and providing the adjusted portion of the training data (e.g., machine learning training data 136 of FIG. 1, feature engineering step 206 of FIG. 2) to the one or more auto-tilt optimization models. Based on the one or more auto-tilt optimization models receiving the adjusted portion of the training data, a third vertical tilt angle may be determined to be applied to the second antenna of the base station in response to one or more KPI predictions generated for the third vertical tilt angle. As such, the second antenna of the base station may be subsequently adjusted based on the third vertical tilt angle determined.

In another example embodiments, feedback from a network component client (e.g., associated with the adjusted antenna of the base station) may be received based on adjusting the vertical tilt angle of the antenna (e.g., the feedback including a covered hexbin associated with this antenna of the base station). A portion of the training data may be adjusted based on the feedback and based on providing the adjusted portion of the training data to the one or more auto-tilt optimization models. Based on the one or more auto-tilt optimization models receiving the adjusted portion of the training data, a second vertical tilt angle may be determined to be applied to the antenna of the base station in response to one or more KPI predictions generated for the second vertical tilt angle. As such, the antenna of the base station may be readjusted based on the second vertical tilt angle (i.e., based on reinforcement learning by the one or more auto-tilt optimization models and the feedback 222 of FIG. 2).

### Example Network Component Client

Referring now to FIG. 4, a diagram is depicted of an example network component client suitable for use in implementations of the present disclosure. In particular, the example network component client is shown and designated generally as network component client 400. Example network component client 400 is but one example of a suitable computing environment and is not intended to suggest any limitation as to the scope of use or functionality of the invention. Neither should network component client 400 be interpreted as having any dependency or requirement relating to any one or combination of components illustrated.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 4, network component client 400 includes bus 402 that directly or indirectly couples the following devices: memory 404, one or more processors 406, one or more presentation components 408, auto-tilt optimization interface 410, data store interface 412, and power supply 414. The memory 404 may include auto-tilt optimization associated operating instructions 404A, which may be executed by the processor(s) 406 to perform auto-tilt optimization associated operations 406A. The one or more presentation components 408 may include auto-tilt optimization interface display 408A (e.g., for displaying KPI prediction(s) 216 of FIG. 2, a recommended number of sectors to tilt change at step 220 of FIG. 2, vertical tilt angles determined by auto-tilt optimization engine 120 of FIG. 1, etc.).

Although the components of FIG. 4 are shown with lines for the sake of clarity, in reality, delineating various components is not so clear, and metaphorically, the lines would more accurately be grey and fuzzy. For example, processors, such as one or more processors 406, have memory. The present disclosure hereof recognizes that such is the nature of the art, and reiterates that FIG. 4 is merely illustrative of an example network component client 400 that may be used in connection with one or more implementations of the present disclosure.

In some embodiments, the network component client 400 may be a “workstation,” “server,” “laptop,” “handheld device,” “computing device,” a tilt adjustment controller unit, etc. In some embodiments, the network component client 400 may be network component client 102 of FIG. 1.

In some embodiments, bus 402 may represent what may be one or more busses (such as an address bus, data bus, or combination thereof).

The network component client 400 may include a variety of computer-readable media. Computer-readable media may be any available media that may be accessed by network component client 400 and may include both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information, such as computer-readable instructions, data structures, program modules, or other data.

Computer storage media may include RAM, ROM, EEPROM, flash memory or other memory technology, CD-ROM, DVD or other optical disk storage, magnetic cassettes, magnetic tape, magnetic disk storage, or other magnetic storage devices. Computer storage media does not comprise a propagated data signal.

Communication media typically embodies computer-readable instructions, data structures, program modules, or other data in a modulated data signal, such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media such as acoustic, RF, infrared, and other wireless media. Combinations of any of the above should also be included within the scope of computer-readable media.

In embodiments, memory 404 includes computer-storage media in the form of volatile and/or nonvolatile memory. Memory 404 may be removable, non-removable, or a combination thereof. Examples of memory 404 may include solid-state memory, hard drives, optical-disc drives, etc., or one or more combinations thereof.

Example network component client 400 also includes one or more processors 406 that read data from one or more entities, such as bus 402, memory 404, one or more presentation components 408, auto-tilt optimization interface 410, data store interface 412, or power supply 414. Examples of one or more processors 406 may include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, other types of processors, or one or more combinations thereof.

One or more presentation components 408 may present (e.g., to a person or other device) data indications. Examples of the one or more presentation components 408 may include a display device, speaker, printing component, vibrating component, etc. In an embodiment, auto-tilt optimization interface 410 may allow network component client 400 to be communicatively coupled to auto-tilt optimization engine 120 of FIG. 1 or other devices. In some embodiments, auto-tilt optimization interface 410 may be auto-tilt optimization interface 104 of FIG. 1. In some embodiments, the one or more presentation components 408 may present data received via the auto-tilt optimization interface 410 or the data store interface 412. In some embodiments, the data store interface 412 may allow network component client 400 to be communicatively coupled to database 130 of FIG. 1 or data store 202 of FIG. 2.

In embodiments, the network component client 400 facilitates communication with a wireless telecommunications network (e.g., via a radio). Illustrative wireless telecommunications technologies may include CDMA, GPRS, TDMA, GSM, and the like. The network component client 400 might additionally or alternatively facilitate other types of wireless communications including Wi-Fi, WiMAX, LTE, or other VoIP communications. As can be appreciated, in various embodiments, network component client 400 may be configured to support multiple technologies and/or multiple radios may be utilized to support multiple technologies.

A wireless telecommunications network might include an array of devices, which are not shown so as to not obscure more relevant aspects of the invention. Components, such as a base station, a communications tower, one or more satellites, other access points (as well as other network components), or one or more combinations thereof, may provide wireless connectivity in some embodiments.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned may be completed without departing from the scope of the claims below. Certain features and sub-combinations are of utility and may be employed without reference to other features and sub-combinations and are contemplated within the scope of the claims.

In the preceding Detailed Description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

The invention claimed is:

1. An auto-tilt optimization system, the system comprising:
one or more processors; and
computer memory storing computer-usable instructions that, when executed by the one or more processors, cause the one or more processors to perform operations comprising:
receiving baseline tilt data and user equipment (UE) measurement data associated with sectors of a base station;
training one or more auto-tilt optimization models using training data generated based at least in part on the baseline tilt data and the UE measurement data;
determining a vertical tilt angle to be applied to an antenna of the base station based on key performance indicator (KPI) predictions associated with a plurality of vertical tilt angles, the KPI predictions generated using the trained one or more auto-tilt optimization models; and
adjusting the antenna of the base station based on the vertical tilt angle.

2. The auto-tilt optimization system according to claim 1, the operations further comprising:
determining a second vertical tilt angle to be applied to a second antenna of the base station, the second antenna of the base station corresponding to a different sector than the sector of the antenna, the second vertical tilt angle determined based on a second set of KPI predictions associated with a plurality of vertical tilt angles for the second antenna, the second set of KPI predictions generated using the trained one or more auto-tilt optimization models; and
adjusting the second antenna of the base station based on the second vertical tilt angle.

3. The auto-tilt optimization system according to claim 2, the operations further comprising:
receiving feedback from a network component client associated with the adjustment to the second antenna of the base station based on the second vertical tilt angle, the feedback including a covered hexbin associated with the second antenna of the base station;
adjusting a portion of the training data based on the feedback and providing the adjusted portion of the training data to the one or more auto-tilt optimization models;
determining a third vertical tilt angle to be applied to the second antenna of the base station based on a KPI prediction generated based on the one or more auto-tilt optimization models receiving the adjusted portion of the training data; and
adjusting the second antenna of the base station based on the third vertical tilt angle.

4. The auto-tilt optimization system according to claim 1, the operations further comprising generating the training data using a set of baseline tilt data and UE measurement data for a plurality of antennas each corresponding to one of a plurality of base stations, including the base station.

5. The auto-tilt optimization system according to claim 1, wherein the baseline tilt data and the UE measurement data include Reference Signal Received Power (RSRP) associated with the sectors of the base station, a number of UEs utilizing a frequency band provided at each of the sectors, an amount of data transmitted to the UEs within each of the sectors over a downlink provided by the base station, an antenna gain associated with each antenna for each of the sectors, and a height of the base station.

6. The auto-tilt optimization system according to claim 5, wherein the KPI predictions include RSRP associated with the sectors of the base station, covered hexbin associated with the sectors of the base station, and downlink volume per user device associated with the sectors of the base station.

7. The auto-tilt optimization system according to claim 1, wherein the one or more auto-tilt optimization models include a light gradient boosting machine, a one-dimensional deep neural network, and a gradient boosting regression model.

8. The auto-tilt optimization system according to claim 1, wherein the KPI predictions are generated by providing weather data, area data, and ground topology data for each of the sectors of the base station as the training data to the one or more auto-tilt optimization models.

9. The auto-tilt optimization system according to claim 1, the operations further comprising:
receiving feedback from a network component client associated with the adjustment to the antenna of the base station based on the vertical tilt angle, the feedback including a covered hexbin associated with the antenna of the base station;
adjusting a portion of the training data based on the feedback and providing the adjusted portion of the training data to the one or more auto-tilt optimization models;
determining a second vertical tilt angle to be applied to the antenna of the base station based on a KPI prediction generated based on the one or more auto-tilt optimization models receiving the adjusted portion of the training data; and
adjusting the antenna of the base station based on the second vertical tilt angle.

10. A method for auto-tilt optimization, the method comprising:
receiving baseline tilt data and user equipment (UE) measurement data associated with sectors of a base station;
training one or more auto-tilt optimization models using training data generated based at least in part on the baseline tilt data and the UE measurement data;
determining a vertical tilt angle to be applied to an antenna of a second base station based on key performance indicator (KPI) predictions associated with a plurality of vertical tilt angles for the antenna of the second base station, the KPI predictions generated using the trained one or more auto-tilt optimization models; and
adjusting the antenna of the second base station based on the vertical tilt angle.

11. The method according to claim 10, wherein determining the vertical tilt angle includes providing a change, between a current vertical tilt angle of the antenna of the second base station and each of the plurality of vertical tilt angles associated with the KPI predictions, to the one or more auto-tilt optimization models.

12. The method according to claim 11, wherein the one or more auto-tilt optimization models include a light gradient boosting machine, a one-dimensional deep neural network, and a gradient boosting regression model.

13. The method according to claim 12, wherein the KPI predictions are generated by providing weather data, area data, and ground topology data for each of the sectors of the base station as the training data to the one or more auto-tilt optimization models.

14. The method according to claim 13, wherein the baseline tilt data and the UE measurement data include Reference Signal Received Power (RSRP) associated with the sectors of the base station, a number of UEs utilizing a frequency band provided at each of the sectors, an amount of data transmitted to the UEs within each of the sectors over a downlink provided by the base station, an antenna gain associated with each antenna for each of the sectors, and a height of the base station, and wherein the KPI predictions include RSRP associated with the second base station, covered hexbin associated with the antenna of the second base station, and downlink volume per user device associated with the antenna of the second base station.

15. One or more computer storage media having computer-executable instructions embodied thereon, that when executed by at least one processor, cause the at least one processor to perform a method comprising:
receiving baseline tilt data and user equipment (UE) measurement data associated with sectors of a base station;
training one or more auto-tilt optimization models using training data generated based at least in part on the baseline tilt data and the UE measurement data;
determining a vertical tilt angle to be applied to an antenna of the base station based on key performance indicator (KPI) predictions associated with a plurality of vertical tilt angles corresponding to the antenna and a sector of the sectors, the KPI predictions generated using the trained one or more auto-tilt optimization models; and
causing the antenna of the base station to be adjusted based on the vertical tilt angle.

16. The one or more computer storage media of claim 15, the method further comprising:
receiving feedback from user devices based on the adjustment to the antenna of the base station, the feedback including Reference Signal Received Power (RSRP) associated with a downlink from the antenna;
adjusting a portion of the training data based on the feedback and providing the adjusted portion of the training data to the one or more auto-tilt optimization models;
determining a second vertical tilt angle to be applied to the antenna of the base station based on a KPI prediction generated based on the one or more auto-tilt optimization models receiving the adjusted portion of the training data; and
adjusting the antenna of the base station based on the second vertical tilt angle.

17. The one or more computer storage media of claim 16, wherein the KPI predictions are generated by providing weather data, area data, and ground topology data for each of the sectors of the base station as the training data to the one or more auto-tilt optimization models, and wherein the KPI prediction is generated by providing weather data, area data, and ground topology data for the antenna to the one or more auto-tilt optimization models.

18. The one or more computer storage media of claim 15, wherein the one or more auto-tilt optimization models include a light gradient boosting machine and a one-dimensional deep neural network.

19. The one or more computer storage media of claim 15, wherein the UE measurement data include Reference Signal Received Power (RSRP) associated with the sectors of the base station.

20. The one or more computer storage media of claim 15, wherein the baseline tilt data associated with the sectors of the base station includes a height for each antenna of the base station.
